(19) United States
(12) Patent Application Publication
(10) Pub. No.: US 2025/0374971 A1
(43) Pub. Date: Dec. 11, 2025

(54) AEROSOL GENERATING DEVICE

(71) Applicant: KT&G CORPORATION, Daejeon (KR)

(72) Inventors: Byung Sung CHO, Gwangmyeong-si (KR); Jong Sub LEE, Seongnam-si (KR); Min Seok JEONG, Seoul (KR)

(73) Assignee: KT&G CORPORATION, Daejeon (KR)

(21) Appl. No.: 19/186,704

(22) Filed: Apr. 23, 2025

(30) Foreign Application Priority Data
Jun. 7, 2024 (KR) 10-2024-0074536

(51) Int. Cl. A24F 40/57; A24F 40/10; A24F 40/42; A24F 40/51; H05B 6/06

(52) U.S. Cl. CPC A24F 40/57; A24F 40/10; A24F 40/42; A24F 40/51; H05B 6/06

(57) ABSTRACT

Provided is an aerosol generating device including a power supply unit, a cartridge including a storage unit storing an aerosol generating material, a liquid delivery element absorbing the aerosol generating material, and a heater configured to receive power from the power supply unit and heat the aerosol generating material absorbed in the liquid delivery element, a resistance sensing unit configured to detect a resistance value of the heater that varies as the heater is heated, and a controller configured to control the power supply unit to supply reference power to the heater and determine depletion of the aerosol generating material absorbed by the liquid delivery element, based on a change in resistance of the heater while the reference power is supplied to the heater.

### CROSS-REFERENCE TO RELATED APPLICATION

This application is based on and claims priority under 35 U.S.C. § 119 to Korean Patent Application No. 10-2024-0074536, filed on Jun. 7, 2024, in the Korean Intellectual Property Office, the disclosure of which is incorporated herein in its entirety by reference.

### BACKGROUND

### 1. Field

The disclosure relate to an aerosol generating device, and more particularly, to an aerosol generating device capable of determining depletion of a liquid delivery element.

### 2. Description of the Related Art

Recently, demand for alternative methods for overcoming shortfalls of general cigarettes has increased. For example, there is an increasing demand for a system for generating an aerosol by heating an aerosol generating material by using an aerosol generating device rather than by burning cigarettes.

In such an aerosol generating system, when the aerosol generating material is a liquid, the aerosol generating material is stored in a storage unit, and a liquid delivery element is arranged within the storage unit to absorb the aerosol generating material. Also, a heater is arranged to surround the liquid delivery element and generates an aerosol by heating the aerosol generating material absorbed by the liquid delivery element. However, the aerosol generating material absorbed by the liquid delivery element may be depleted as used by a user and, when the liquid delivery element is heated with the same power even after the liquid delivery element has been depleted, it may cause user dissatisfaction due to a burnt taste and an unpleasant odor. Therefore, there is a need to detect the depletion of the liquid delivery element and control the power supplied to the heater accordingly.

### SUMMARY

The disclosure provides an aerosol generating device capable of detecting depletion of a liquid delivery element and controlling power supplied to a heater in response to the depletion of the liquid delivery element.

The technical problems of the disclosure are not limited to the above-described description, and other technical problems may be derived from the embodiments to be described hereinafter.

Additional aspects will be set forth in part in the description which follows and, in part, will be apparent from the description, or may be learned by practice of the presented embodiments of the disclosure.

An aerosol generating device according to an embodiment includes a power supply unit, a cartridge including a storage unit storing an aerosol generating material, a liquid delivery element absorbing the aerosol generating material, and a heater configured to receive power from the power supply unit and heat the aerosol generating material absorbed in the liquid delivery element, a resistance sensing unit configured to detect a resistance value of the heater that varies as the heater is heated, and a controller configured to control the power supply unit to supply reference power to the heater and determine depletion of the aerosol generating material absorbed by the liquid delivery element, based on a change in resistance of the heater while the reference power is supplied to the heater.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing an aerosol generating device according to an embodiment;

FIG. 2 is a diagram showing an aerosol generating device according to another embodiment;

FIG. 3 is an internal block diagram of an aerosol generating device according to an embodiment;

FIG. 4 is a partial circuit diagram illustrating a method of sensing the resistance of a heater according to an embodiment;

FIG. 5 is a diagram for describing changes in the resistance due to depletion of a liquid delivery element;

FIG. 6 is a diagram for describing a method of determining depletion of a liquid delivery element in a first sensing section according to an embodiment and a power control method according to the same;

FIG. 7 is a diagram for describing a method of determining depletion of a liquid delivery element in a second sensing section and a third sensing section according to an embodiment and a power control method according to the same;

FIG. 8 is a flowchart illustrating a method of determining depletion of a liquid delivery element in a first sensing section according to an embodiment;

FIG. 9 is a flowchart illustrating a method of determining depletion of a liquid delivery element in a second sensing section and a third sensing section, according to an embodiment; and

FIG. 10 is a flowchart illustrating a power control method according to depletion of a liquid delivery element and a method of determining depletion of a storage unit according to an embodiment.

### DETAILED DESCRIPTION

Hereinafter, embodiments of the disclosure will be described in detail with reference to the attached drawings. Regardless of the drawing symbols, identical or similar components will be given the same reference numerals and redundant descriptions thereof will be omitted.

The suffixes ‘module’ and ‘unit’ may be used for elements in order to facilitate the disclosure. Significant meanings or roles may not be given to the suffixes themselves and it is understood that the ‘module’ and ‘unit’ may be used together or interchangeably.

Also, in descriptions of embodiments of the disclosure, if it is determined that detailed description of a related known technology may obscure the gist of embodiments of the disclosure, the detailed descriptions thereof are omitted. Also, the attached drawings are only intended to facilitate easy understanding of the embodiments disclosed in the present specification, and the technical ideas disclosed in the present specification are not limited by the attached drawings, and should be understood to include all modifications, equivalents, or substitutes included in the spirit and technical scope of the disclosure.

While such terms as “first,” “second,” etc., may be used to describe various elements, such elements must not be limited to the above terms. The above terms may be used only to distinguish one element from another.

It is to be understood that when an element is described as being “on” or “in contact with” another element, it is to be understood that other elements may directly contact or be directly connected to the other element or intervening element may be present therebetween. On the other hand, when an element is described as being “directly on” or “directly in contact with” another element, it may be understood that there is no other element therebetween.

An expression used in the singular encompasses the expression of the plural, unless it has a clearly different meaning in the context.

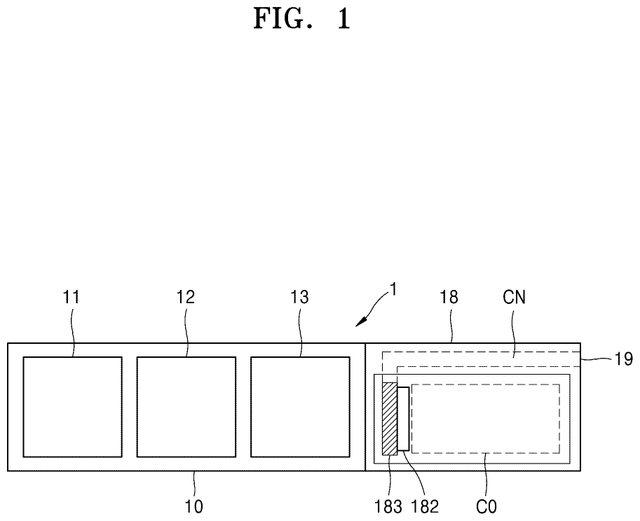

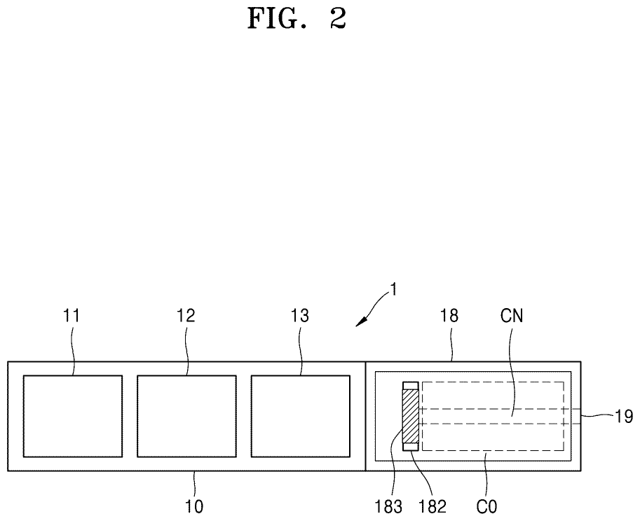

FIG. 1 is a diagram showing an aerosol generating device according to an embodiment, and FIG. 2 is a diagram showing an aerosol generating device according to another embodiment.

Referring to FIGS. 1 and 2, an aerosol generating device 1 may include a body 10 and a cartridge 18. The aerosol generating device 1 may include at least one of a power supply unit 11, a controller 12, and a sensing unit 13. At least one of the power supply unit 11, the controller 12, and the sensing unit 13 may be placed inside the body 10. The body 10 may be equipped with a cartridge 18, which is an aerosol generating article. A user may inhale an aerosol by placing a mouthpiece provided at one end of the cartridge 18 in his/her mouth.

The cartridge 18 may contain, in a chamber CO therein, an aerosol generating material in any one of a liquid state, a solid state, a gaseous state, or a gel state. The aerosol generating material may include a liquid composition. For example, the liquid composition may be a liquid including a tobacco-containing material containing volatile tobacco flavor components or may be a liquid including a non-tobacco material.

The cartridge 18 may be detachably coupled to the body 10. The cartridge 18 may be mounted on the body 10 by being inserted into the body 10.

The body 10 may be formed into a structure in which outside air may flow into the interior of the body 10 while the cartridge 18 is inserted. At this time, the outside air introduced into the body 10 may pass through the cartridge 18 and flow into the oral cavity of a user through an airflow channel CN.

The cartridge 18 may include the chamber CO containing an aerosol generating material and/or a heater 183 for heating the aerosol generating material in the chamber CO. A liquid delivery element 182 impregnated with (containing) an aerosol generating material may be placed inside the chamber CO. Here, the liquid delivery element 182 may include a wick such as cotton fiber, ceramic fiber, glass fiber, or porous ceramic. An electro-conductive track of the heater 183 may be formed as a coil-shaped structure wound around the liquid delivery element 182 or a structure that contacts one side of the liquid delivery element 182. The heater 183 may also be referred to as a cartridge heater.

The cartridge 18 may generate an aerosol. As the liquid delivery element 182 is heated by the heater 183, an aerosol may be generated. A generated aerosol may be inhaled into the oral cavity of a user through the airflow channel CN.

The airflow channel CN may be provided in the cartridge 18. The airflow channel CN may communicate between the chamber CO in which the heater 183 of the cartridge 18 is placed and the outside of the cartridge 18. One end of the airflow channel CN is opened to the chamber CO in which the heater 183 is placed, and the other end may be connected to a mouthpiece 19. For example, referring to FIG. 1, the airflow channel CN may extend in the length-wise direction of the cartridge 18 from one side of the chamber CO of the cartridge 18. For example, referring to FIG. 2, the airflow channel CN may extend in the length-wise direction of the cartridge 18 by penetrating through the chamber CO of the cartridge 18.

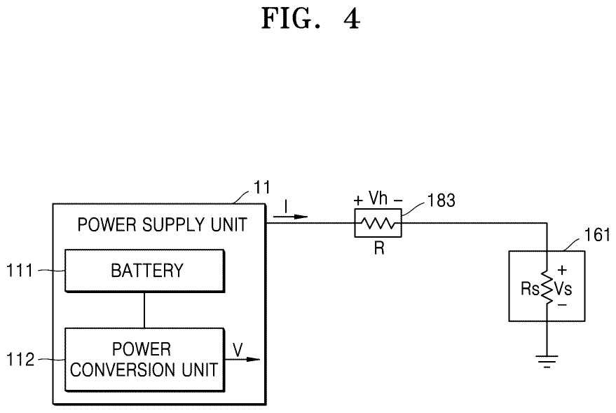

The power supply unit 11 may supply power to operate components of the aerosol generating device 1. The power supply unit 11 may include a battery (111 of FIG. 4). The power supply unit 11 may supply power to at least one of the controller 12, the sensing unit 13, and the heater 183.

The controller 12 may control the overall operation of the aerosol generating device 1. The controller 12 may be mounted on a printed circuit board (PCB). The controller 12 may control the operation of at least one of the power supply unit 11, the sensing unit 13, and the cartridge 18. The controller 12 may control the operation of a display, a motor, etc. installed in the aerosol generating device 1. The controller 120 may check the status of each of the components of the aerosol generating device 1 and determine whether the aerosol generating device 1 is in an operable state.

The controller 12 may analyze a result detected by the sensing unit 13 and control processes to be performed thereafter. For example, the controller 12 may control power supplied to the heater 183 based on a result detected by the sensing unit 13, such that the operation of the heater 183 is started or ended. For example, based on a result detected by the sensing unit 13, the controller 12 may control an amount of power supplied to the heater 183 and the time for which the power is supplied, such that the heater 183 may be heated to a certain temperature or maintain an appropriate temperature.

The sensing unit 13 may include at least one of a temperature sensor, a puff sensor, a cartridge detection sensor, and a motion detection sensor. For example, the sensing unit 13 may sense at least one of the temperature of the heater 183, the temperature of the power supply unit 11, and the temperatures inside and outside the body 10. For example, the sensing unit 13 may sense a puff of a user. For example, the sensing unit 13 may sense whether a cartridge is mounted. For example, the sensing unit 13 may sense a movement of the aerosol generating device 1.

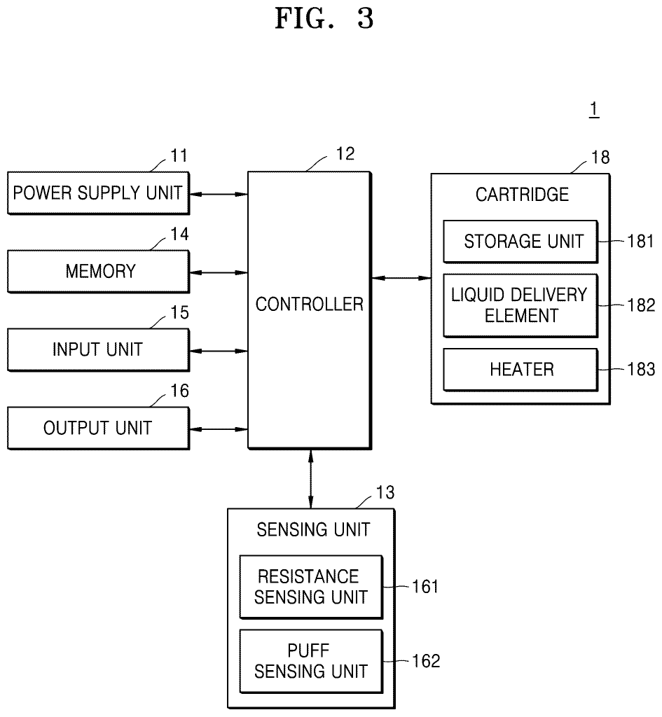

FIG. 3 is an internal block diagram of an aerosol generating device according to an embodiment.

Referring to FIG. 3, the aerosol generating device 1 may include at least one of the power supply unit 11, the cartridge 18, the sensing unit 13, the controller 12, a memory 14, an input unit 15, and an output unit 16. Meanwhile, the aerosol generating device 1 according to the disclosure may further include other general-purpose components in addition to the components illustrated in FIG. 3. For example, the aerosol generating device 1 may further include a communicator (not shown) for communicating with an external device.

The power supply unit 11 supplies electric power used for the aerosol generating device 1 to operate. For example, the power supply unit 11 may supply power to at least one of the cartridge 18, the sensing unit 13, the controller 12, the memory 14, the input unit 15, and the output unit 16. The power supply unit 11 may include the battery (111 of FIG. 4) and a power conversion unit (112 of FIG. 4).

The battery 111 may be configured as a removable battery that is detachably placed in the aerosol generating device 1. Alternatively, the battery 111 may be fixed to the aerosol generating device 1. Here, the battery 111 may be rechargeable or a disposable battery. For example, the battery 111 may be a lithium polymer (LiPoly) battery, but is not limited thereto.

The power conversion unit 112 includes a DC-DC converter that boosts or lowers direct current power, and the DC-DC converter may provide converted power to the internal components of the aerosol generating device 1. When the heater 183 of the cartridge 18 is heated by an induction heating method, the power conversion unit 112 further includes a direct current (DC)-alternating current (AC) converter, and the DC-AC converter may convert DC power into AC power and provide the AC power to the heater 183.

The cartridge 18 may include a storage unit 181, the liquid delivery element 182, and the heater 183.

The storage unit 181 may store an aerosol generating material. When the chamber CO of FIGS. 1 and 2 has a function of storing an aerosol generating material, the chamber CO of FIGS. 1 and 2 may have a configuration corresponding to that of the storage unit 181 of FIG. 3. At least one side of the storage unit 181 is open, and the opening may be communicated with the airflow channel CN. The liquid delivery element 182 is disposed within the storage unit 181 and may be exposed to the aerosol generating material stored in the storage unit 181.

The liquid delivery element 182 may absorb the aerosol generating material. According to an embodiment, the liquid delivery element 182 may include a wick such as cotton fiber, ceramic fiber, glass fiber, or porous ceramic.

The heater 183 may be formed as a coil-shaped structure wound around the liquid delivery element 182 or a structure that contacts one side of the liquid delivery element 182. The heater 183 may be configured as an electrically resistive heater or an induction heater.

When the heater 183 is configured as an electrically resistive heater, the heater 183 includes an electro-conductive track and may perform resistance heating by power provided from the power supply unit 11.

When the heater 183 is configured as an induction heater, the heater 183 may include at least one of ferrite, a ferromagnetic alloy, stainless steel, and aluminum (Al). Furthermore, the heater 183 may include graphite, molybdenum, silicon carbide, niobium, niobium, a nickel alloy, a metal film, a ceramic like zirconia, a transition metal such as nickel (Ni) and cobalt (Co), and a metalloid like boron (B) and phosphorus (P). When the heater 183 is configured as an induction heater, the aerosol generating device 1 further includes an induction coil for inductively heating the heater 183, and the heater 183 may be heated by an induced magnetic field generated from the induction coil. At this time, the induction coil may be placed in the cartridge 18 or in the body 10.

The heater 183 may generate an aerosol by heating an aerosol generating material absorbed by the liquid delivery element 182. A generated aerosol may be inhaled into the oral cavity of a user through the airflow channel CN.

The sensing unit 13 may sense various status information of the aerosol generating device 1. A result sensed by the sensing unit 13 is transmitted to the controller 12, and the controller 12 may control the aerosol generating device 1 to perform various functions such as controlling the operation of a heating unit, restricting smoking, determining whether the cartridge 18 is inserted, and displaying notifications according to the result sensed by the sensing unit 13.

The sensing unit 13 may include a resistance sensing unit 161 and a puff sensing unit 162.

The resistance sensing unit 161 may sense a change in the resistance of the heater 183. When the heater 183 includes an electro-conductive track, the electro-conductive track may have a variable resistance depending on the temperature, and the resistance sensing unit 161 may detect a resistance value according to a temperature change of the heater 183. For example, the resistance of the heater 183 may increase as the temperature increases, and the resistance sensing unit 161 may output the resistance value of the heater 183 at a preset cycle or in real time and transmit the resistance value to the controller 12. The resistance sensing unit 161 includes a shunt resistor connected in series or parallel with the heater 183, and the resistance sensing unit 161 may output the resistance value of the heater 183 by estimating the resistance of the heater 183 from the resistance value of the shunt resistor. Alternatively, the resistance sensing unit 161 may measure the resistance of the heater 183 itself. However, the resistance measuring method of the heater 183 is not limited to the examples described above, and various resistance measuring methods of the heater 183 may be applied.

The puff sensing unit 162 may detect a user's puff. To this end, the puff sensing unit 12) may include a pressure sensor, a flow sensor, an airflow sensor, and a microphone. However, the puff detection means are not limited to the examples described above. The puff sensing unit 162 may detect each puff separately. Each puff may appear as a continuous section from a puff start time to a puff end time, and the puff sensing unit 162 may also count the number of puffs.

Meanwhile, the sensing unit 13 of FIG. 3 illustrates components related to the present embodiment. Therefore, it will be understood by one of ordinary skill in the art that general-purpose components other than the components shown in FIG. 3 may be further included in the sensing unit 13. For example, the sensing unit 13 may further include a water detection sensor that detects water inside and/or outside the aerosol generating device 1, a cartridge insertion sensor, a separate temperature sensor, etc.

The memory 14 may be a hardware component storing various pieces of data processed in the aerosol generating device 1, and the memory 14 may store data processed or to be processed by the controller 12. The memory 170 may include various types of memories, such as random access memory, such as dynamic random access memory (DRAM), static random access memory (SRAM), etc., read-only memory (ROM), electrically erasable programmable read-only memory (EEPROM), etc. According to an embodiment, the memory 14 may store information regarding reference power and compensation power supplied to the heater 183 or information regarding a sensing section. Also, the memory 14 may store a resistance change criterion for each sensing section of the heater 183.

The input unit 15 may receive user input. The input unit 15 may be implemented with a physical key and/or a touch sensor for receiving user input. According to embodiments, the input unit 15 may be omitted. In this case, the heater 183 may be heated by the inhalation of a user. For example, the input unit 15 may include, but is not limited to, a button, a key pad, a dome switch, a jog wheel, and a jog switch.

The output unit 16 may include a display for outputting visual information related to the aerosol generating device 1. Also, the output unit 16 may include a motor for outputting tactile information related to the aerosol generating device 1. Here, visual information and tactile information related to the aerosol generating device 1 include all information related to the operation of the aerosol generating device 1. For example, the output unit 16 may output information regarding the depletion of the liquid delivery element 182 and/or information regarding the depletion of the storage unit 181. To this end, the output unit 16 may include a display and a haptic motor. The display may include a liquid crystal display panel (LCD) or an organic light-emitting display panel (OLED). Meanwhile, when a display and a touch pad are configured in a layered structure to form a touch screen, the display may be used as an input device in addition to an output device. The haptic motor may convert an electrical signal into a mechanical stimulus or an electrical stimulus to provide tactile information regarding the aerosol generating device 1 to a user.

The controller 12 controls the overall operation of the aerosol generating device 1. According to an embodiment, the controller 12 may include at least one processor. A processor can be implemented as an array of a plurality of logic gates or can be implemented as a combination of a general-purpose microprocessor and a memory in which a program executable in the microprocessor is stored. Also, it may be understood by one of ordinary skill in the art that the processor may be implemented as other types of hardware.

The controller 12 receives user input through the input unit 15 and may control the power supplied to the heater 183 according to the user input. According to embodiments, the controller 12 may control the power supply unit 11 to control the power supplied to the heater 183 when the puff sensing unit 162 detects a puff of a user. Also, the controller 12 may control the output unit 16 to output information regarding the depletion of the liquid delivery element 182 due to heating to the heater 183 and/or information regarding the depletion of the storage unit 181.

Meanwhile, the aerosol generating material absorbed by the liquid delivery element 182 may become insufficient due to frequent puffs by a user, decreased absorption capacity of the liquid delivery element 182, long-term non-use of aerosol generating device, and depletion of the storage unit 181. When the liquid delivery element 182 is heated with the same power even though a material absorbed by the liquid delivery element is insufficient, the liquid delivery element 182 may be carbonized, providing a carbonized taste and an unpleasant odor to a user. To solve the problem, according to the disclosure, a shortage of an aerosol generating material in advance absorbed by the liquid delivery element 182 may be detected in advance, and power supplied to the heater 183 may be controlled in response to the shortage of the aerosol generating material. Meanwhile, according to the disclosure, the shortage (or exhaustion) may mean that the aerosol generating material absorbed by the liquid delivery element 182 is less than a pre-set reference absorption amount and may be used in the same sense as depletion. For example, the reference absorption amount may be set to 9.16 mg.

Hereinafter, a method of detecting depletion of the liquid delivery element 182 and a power control method according to the same will be described.

FIG. 4 is a partial circuit diagram illustrating a method of sensing the resistance of a heater according to an embodiment.

Referring to FIG. 4, the power supply unit 11 may include the battery 111 and the power conversion unit 112. The battery 111 may output DC power. The power conversion unit 112 includes a DC-DC converter that boosts or lowers DC power, and the DC-DC converter may output boosted or lowered DC power. In FIG. 4, a converted DC power output from the power conversion unit 112 is expressed as an input voltage V applied to loads R and Rs. The input voltage V is a constant voltage, and the magnitude thereof may be adjusted by the controller 12.

An input current I may be applied to the heater 183 by the input voltage V output by the power conversion unit 112. The heater 183 may include a material having a resistance temperature coefficient α. Therefore, the heater 183 may have a resistance value R varying depending on the temperature. Meanwhile, the resistance value R of the heater 183 may also be referred to as a current resistance value R to be distinguished from a reference resistance R0 of the heater 183 described later.

As the resistance value R of the heater 183 varies according to the temperature, the input current I may also vary with respect to the input voltage V, which is a constant voltage. The resistance sensing unit 161 includes a shunt resistor and may detect changes in the input current I through the shunt resistor. Also, the resistance sensing unit 161 may obtain the resistance value R of the heater 183 from the input current I.

In FIG. 4, the shunt resistor is shown as a resistive element having a shunt resistance value Rs. Also, although the shunt resistor in FIG. 4 is illustrated as being connected in series to the heater 183, according to embodiments, the shunt resistor may be connected in parallel to the heater 183.

A shunt resistance has a constant value even when the temperature varies, and may be set to be much smaller than the resistance value R of the heater 183. For example, the shunt resistance value Rs may be set to be smaller than 1/10 times the resistance value R of the heater 183, but is not limited thereto. The purpose of setting the shunt resistance value Rs small is to minimize power consumed by the shunt resistor, the power that needs to be used for heating the heater 183.

A shunt resistor connected in series with the heater 183 may be used to sense the input current I. The resistance sensing unit 161 includes a voltmeter and may obtain a voltage Vs across two ends of the shunt resistor. Since the shunt resistance value Rs is constant regardless of the temperature, the resistance sensing unit 161 may obtain the input current I from the voltage Vs across two ends of the shunt resistor.

A voltage Vh across two ends of the heater 183 may be obtained from the difference between the input voltage V and the voltage Vs across two ends of the shunt resistor, and the resistance sensing unit 161 may obtain the current resistance value R of the heater 183 based on the voltage Vh across two ends of the heater 183 and the input current I.

Meanwhile, a current resistance value R of the heater 183 may also be used to estimate the temperature of the heater 183. The reference resistance R0 of the heater 183 at a reference temperature TO and the current resistance value R of the heater 183 at a current temperature T may satisfy the Equation 1 below when a resistance temperature coefficient is a.

$$R = {R}_{0} \{ 1 + α ( T - {T}_{0} ) \} \qquad [ Equation 1 ]$$

At this time, the reference temperature TO is 25° C., and the reference resistance R0 may mean the resistance value of the heater 183 measured through repeated experiments at 25° C. The controller 12 may also estimate the current temperature T of the heater 183 from the current resistance value R using Equation 1. In this way, when the controller 12 calculates the temperature of the heater 183 based on the resistance of the heater 183, a separate temperature sensor may not be needed.

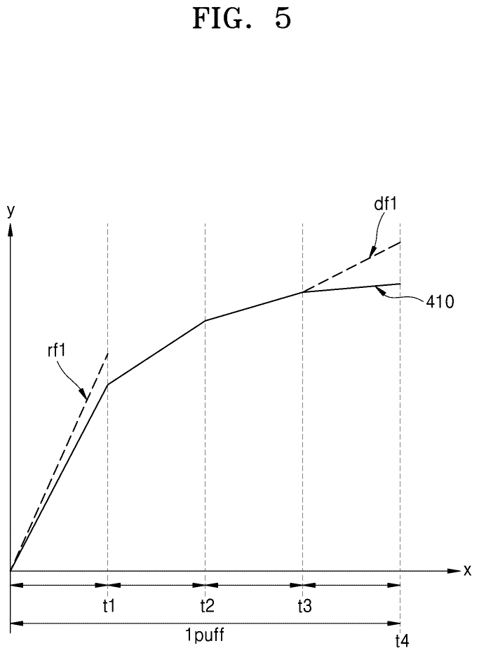

FIG. 5 is a diagram for describing changes in the resistance due to depletion of a liquid delivery element.

FIG. 5 shows a graph 410 of resistance change over time in one puff section (1 puff). In FIG. 5, the x-axis represents time (sec) and the y-axis represents resistance (Ω).

Referring to FIG. 5, when the puff sensing unit 162 detects a puff of a user, the controller 12 may supply reference power to the heater 183 from a puff start time to a puff end time. For example, a time from the puff start time to the puff end time may include a first time t1 to a fourth time t4, and each time may be set to 0.5 seconds. Also, the reference power may be, but is not limited to, 7 W.

The resistance of the heater 183 is proportional to the temperature, and, when the heater 183 is supplied with standard power, the heater 183 is heated and the temperature increases, and thus the resistance of the heater 183 may also increase over time. The following description is based on the resistance of the heater 183, but the following description may also be applied to the temperature of the heater 183.

The resistance of the heater 183 may initially rise rapidly as the reference power is supplied. Since the reference power supplied to the heater 183 is set based on a normal state in which the aerosol generating material absorbed by the liquid delivery element 182 is sufficient, when the reference power is supplied to the heater 183 even though the liquid delivery element 182 is depleted at the beginning of heating, the resistance of the heater 183 in this state increases faster than the resistance of the heater 183 in the normal state. According to an embodiment, when the liquid delivery element 182 is depleted in the first time t1, the resistance of the heater 183 may increase at a rate faster than a reference change amount rf1. The reference change amount rf1 means the change amount of resistance of the heater 183 per unit time, and thus the reference change amount rf1 may be referred to as a reference change rate and a reference slope. At this time, the unit time may be the first time t1. For example, the reference change amount may be set to, but is not limited to, 4 [Ω/sec].

When the reference power is supplied to the heater 183 in the second time t2 to the fourth time t4, the change amount of the resistance of the heater 183 in the second time t) to the fourth time t4 may be smaller than the change amount of the resistance of the heater 183 in the first time t1. This is because not only does the rate of increase in resistance decrease as the threshold resistance of the heater 183 is reached, but also the liquid delivery element 182 absorbs the aerosol generating material from the storage unit 181 in response to a heated aerosol generating material. The threshold resistance is set based on the maximum heating temperature of the heater 183 and may depend on the components of the heater 183. However, the liquid delivery element 12) may be temporarily or non-temporarily depleted due to frequent puffs by a user, a decrease in the absorbency of the liquid delivery element 182, and depletion of the storage unit 181. The depletion of the liquid delivery element 182 may occur continuously during the initial puff, or may occur discontinuously during the initial puff. FIG. 5 is a diagram showing a portion of a graph df1 in which depletion of the liquid delivery element 182 occurs discontinuously from the third time t3 to the fourth time t4 after the first time t1, which corresponds to the initial puff.

In FIG. 5, when the liquid delivery element 182 is depleted in the third time t3 to the fourth time t4, the resistance of the heater 183 increases at a rapid rate similar to that in the first time t1, which is the initial heating section. In particular, during the third time t3 to the fourth time t) when the liquid delivery element 182 is depleted, less material is heated than during the previous heating sections, i.e., the second time t2 to the third time t3, and thus the resistance of the heater 183 during the third time t3 to the fourth time t4 increases at a faster rate than that during the previous heating section, i.e., the second time t2 to the third time t3. However, the resistance changing slope of the heater 183 in the third time t3 to the fourth time t4 is smaller than the resistance changing slope of the heater 183 in the first time t1. This is because not only does the rate of increase in resistance decrease as the threshold resistance of the heater 183 is reached, but also the liquid delivery element 182 absorbs an amount of the aerosol generating material less than that in a normal state from the storage unit 181 in response to a heated aerosol generating material. Therefore, in the third time t3 to the fourth time t4, the depletion of the liquid delivery element 182 may not be determined based on the reference change amount rf1 in the same way as in the first time t1.

Meanwhile, when the same reference power is supplied to the heater 183 even though the liquid delivery element 182 is depleted in the initial puff section or a subsequent section after the initial puff section, the liquid delivery element 182 may be carbonized. To solve this problem, the disclosure controls power supplied to the heater 183 in response to the depletion of the liquid delivery element 182.

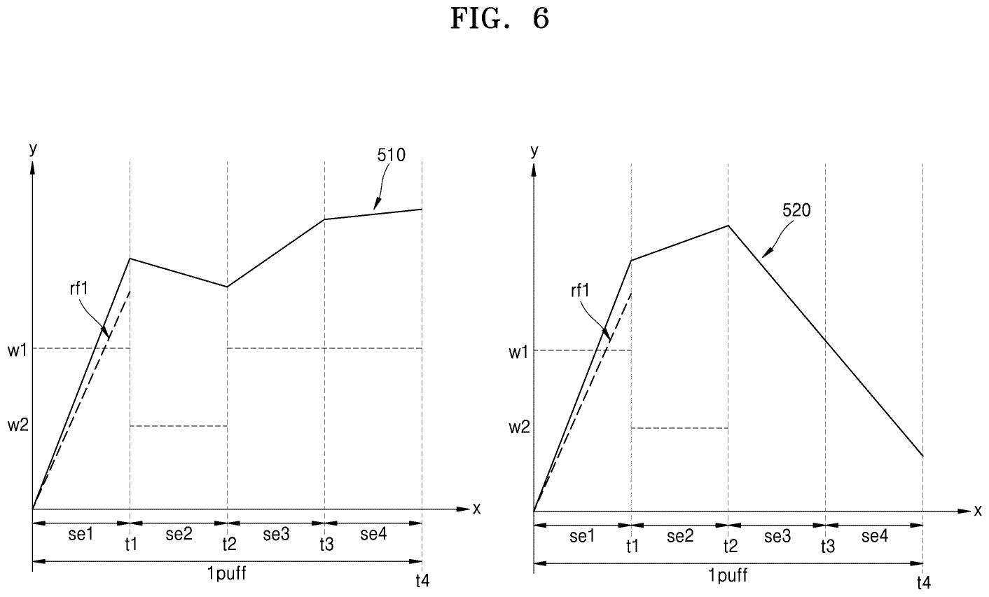

FIG. 6 is a diagram for describing a method of determining depletion of a liquid delivery element in a first sensing section according to an embodiment and a power control method according to the same.

FIG. 6 shows a diagram 510 in which depletion of the liquid delivery element 182 is resolved by providing compensation power to the heater 183 according to depletion of the liquid delivery element 182 and a diagram 520 in which depletion of the liquid delivery element 182 is not resolved, in a first sensing section se1 at the beginning of a puff.

Referring to FIG. 6, the same method of determining depletion of the liquid delivery element 182 in the first sensing section se1 is used in the diagram 510 and the diagram 520.

In the diagram 510 and the diagram 520, the controller 12 may divide one puff section (1 puff) including a puff start time and a puff end time into a plurality of sensing sections se1 to se4. The plurality of sensing sections se1 to se4 (hereinafter collectively referred to as se when there is no need for distinction) may include the first sensing section se1 from the puff start time to the first time t1, a second sensing section se2 from the first time t1 to the second time t2, a third sensing section se3 from the second time t2 to the third time t3, and a fourth sensing section se4 from the third time t3 to the fourth time t4. Each sensing section is set to the same length. For example, each sensing section may be set to 0.5 seconds, but is not limited thereto. FIG. 6 illustrates an example in which a plurality of sensing sections se are divided into four, but, according to the length of a puff of a user and settings, the plurality of sensing sections se may include less than four or more than four sensing sections.

In the first sensing section se1, which is the beginning of a puff, there is no previous sensing section, and, in the early stage of heating, the need to prevent carbonization of the liquid delivery element 182 due to a rapid temperature increase is greater than that in subsequent sensing sections se2 to se4. Therefore, the controller 12 may determine the depletion of the liquid delivery element 182 in a single sensing section.

The controller 12 may control the power supply unit 11 in the first sensing section se1 to supply reference power w1 to the heater 183. The resistance sensing unit 161 may detect a change in the resistance of the heater 183 when the reference power w1 is supplied to the heater 183. The controller 12 may determine the depletion of the aerosol generating material absorbed by the liquid delivery element 182 based on the change in the resistance of the heater 183 while the reference power w1 is supplied to the heater 183.

The controller 12 may determine that the aerosol generating material absorbed by the liquid delivery element 182 is depleted when the change amount of the resistance of the heater 183 per unit time in the first sensing section se1 is greater than the reference change amount rf1. At this time, the unit time may be the duration of the first sensing section se1 and may be the first time t1. In other words, the controller 12 may determine whether the liquid delivery element 182 is depleted by linearly approximating the change amount of the resistance and the reference change amount in the first sensing section se1 and comparing them. The reference change amount rf1 means the change amount of resistance of the heater 183 per unit time, and thus the reference change amount rf1 may be referred to as a reference change rate and a reference slope. For example, the reference change amount may be set to, but is not limited to, 4 [Q/see]. Therefore, in an embodiment where the reference change amount rf1 is the reference slope, the controller 12 may determine that the aerosol generating material absorbed by the liquid delivery element 182 is depleted when the change amount of the resistance of the heater 183 per unit time is greater than the reference slope (however, the reference slope is positive). In the diagram 510 and the diagram 520, the controller 12 may determine that the liquid delivery element 182 is depleted because the change amount of the resistance of the heater 183 per unit time in the first sensing section se1 is greater than the reference slope rf1.

In the diagram 510 and the diagram 520, when the controller 12 determines that the aerosol generating material absorbed by the liquid delivery element 182 in a current sensing section is depleted, the controller 12 may control the power supply unit 11 in a compensation section subsequent to a current sensing section to supply a compensation power w2 lower than the reference power w1 to the heater 183. In FIG. 6, the current sensing section corresponds to the first sensing section se1 in which depletion of the liquid delivery element 182 is sensed, and the compensation section corresponds to the second sensing section se2 in which the compensation power w2 lower than the reference power w1 is supplied to the heater 183.

In the diagram 510, the controller 12 may determine that the depletion of the aerosol generating material absorbed by the liquid delivery element 182 is resolved when the resistance of the heater 183 decreases in response to the compensation power w2 in the second sensing section se2. The controller 12 may determine whether the depletion of the liquid delivery element 182 is resolved by monitoring the resistance of the heater 183 corresponding to the compensation power w2 in real time or by monitoring the change amount of the resistance of the heater 183 per unit time. In an embodiment where the controller 12 monitors the change amount of the resistance of the heater 183 per unit time, the controller 12 may determine that the depletion of the liquid delivery element 182 has been resolved when the slope of the change amount of the resistance of the heater 183 per unit time is negative in response to the compensation power w2. In other words, the controller 12 may linearly approximate the change amount of the resistance of the heater 183 in the second sensing section se2 and determine whether the depletion of the liquid delivery element 182 is resolved based on the sign of the slope of a linearly approximated change amount of the resistance of the heater 183.

As described later, the controller 12 may select the compensation power w2 within the range from about 0.3 times to about 0.6 times the reference power w1 to distinguish between the depletion of the storage unit 181 and the depletion of the liquid delivery element 182. For example, when the reference power w1 is 7 W, the compensation power w2 may be set to 4 W. In this way, when the reference power w1 and the compensation power are not set to be significantly different from each other, even when the depletion of the liquid delivery element 182 is resolved, the change amount of the resistance of the heater 183 has a positive slope, making it difficult to distinguish between the depletion of the storage unit 181 described below and the depletion of the liquid delivery element 182. Also, the lower limit of the compensation power w2 is set to 0.3 times the reference power w1 to continuously heat the aerosol generating material above a vaporization temperature even in the compensation section.

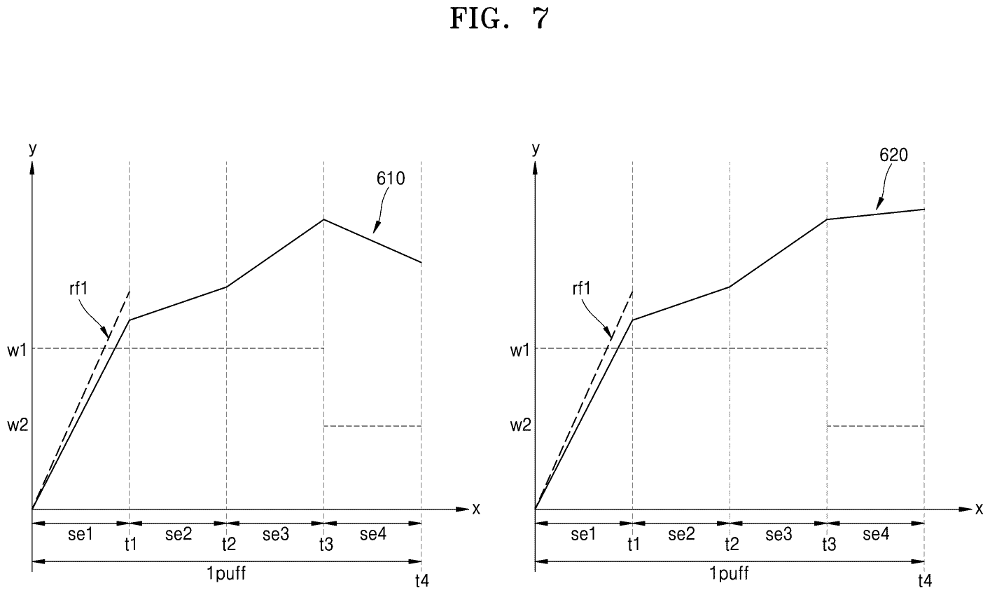

When the controller 12 determines that the depletion of the liquid delivery element 182 has been resolved in the second sensing section se2, which is a compensation section, the controller 12 may control the power supply unit 11 in the third sensing section se3, which is continuous to the compensation section, to supply the reference power w1 to the heater 183 again. When the controller 12 determines that the liquid delivery element 182 is not depleted in the third sensing section se3, the controller 12 may supply the reference power w1 to the heater 183 in the fourth sensing section se4. The method of exhausting the liquid delivery element 182 in subsequent sections after the initial puff section is described below with reference to FIG. 7 and below.

Contrary to the diagram 510, in the diagram 520, even though the controller 12 supplies the compensation power w2 smaller than the reference power w1 to the heater 183 in the second sensing section se2, the resistance of the heater 183 may increase in response to the compensation power w2. When the resistance of the heater 13) increases in response to the compensation power w2 in the second sensing section se2, the controller 12 may determine that the storage unit 181 is depleted and the depletion of the liquid delivery element 182 may not be resolved by controlling power. The controller 12 may determine whether the storage unit 181 is depleted by monitoring the resistance of the heater 183 corresponding to the compensation power w2 in real time or by monitoring the change amount of the resistance of the heater 183 per unit time. In an embodiment where the controller 12 monitors the change amount of the resistance of the heater 183 per unit time, the controller 12 may determine that the storage unit 181 is depleted when the slope of the change amount of the resistance of the heater 183 per unit time is positive in response to the compensation power w2. In other words, the controller 12 may linearly approximate the change amount of the resistance of the heater 183 in the second sensing section se2 and determine whether the storage unit 181 is depleted based on the sign of the slope of a linearly approximated change amount of the resistance of the heater 183.

When the controller 12 determines that the storage unit 181 is depleted in the second sensing section se2, which is the compensation section, the depletion of the liquid delivery element 182 may not be resolved, and thus the controller 12 may control the power supply unit 11 in the third sensing section se3, which is continuous to the compensation section, to cut off power supplied to the heater 183. In other words, since replacement of a cartridge will not be performed in one puff section (1 puff), the controller 12 may control the power supply unit 11 to cut off power supplied to the heater 183 even in the fourth sensing section se4, which is continuous to the third sensing section se3.

Meanwhile, when the controller 12 determines that the storage unit 181 is depleted, the controller 12 may control the output unit 16 to visually, audibly, and tactilely notify the depletion status of the storage unit 181 to a user.

FIG. 7 is a diagram for describing a method of determining depletion of a liquid delivery element in a second sensing section and a third sensing section according to an embodiment and a power control method according to the same.

Referring to FIG. 7, as shown in FIG. 6, the controller 12 may divide one puff section (1 puff) including a puff start time and a puff end time into a plurality of sensing sections se1 to se4. The durations and the number of the plurality of sensing sections se are as described in FIG. 6.

The controller 12 may determine the depletion of the liquid delivery element 182 based on the change in resistance of the heater 183 in subsequent sensing sections se2 to se4 after the first sensing section se1, which is the initial stage of the puff.

Meanwhile, unlike in the first sensing section se1 that is the initial stage of the puff, the change in the resistance of the heater 183 in the subsequent sensing sections se2 to se4 does not significantly vary. This is because the rate of increase in resistance decreases as the threshold resistance of the heater 183 is reached. Therefore, in the subsequent sensing sections se2 to se4, it is difficult to set a reference slope for distinguishing such low slopes. Also, since the resistance of the heater 183 varies in each section, it is difficult to set a reference slope to be commonly applied to each section. To resolve this problem, the disclosure monitors the change amount of the resistance of the heater 183 in a plurality of sensing sections instead of a single sensing section in the subsequent sensing sections se2 to se4 and determines the depletion of the liquid delivery element 182 based on the change amount of the resistance of the heater 183 in the plurality of sensing sections.

In FIG. 7, a diagram 610 in which depletion of the liquid delivery element 182 is resolved by providing compensation power to the heater 183 according to depletion of the liquid delivery element 182 in subsequent sensing sections se2 to se4 after the first sensing section se1, which is the initial stage of the puff, and a diagram 620 in which depletion is not resolved are shown.

The method of determining depletion of the liquid delivery element 182 is the same in the first sensing section se1 to the third sensing section se3 of the diagram 610 and the diagram 620.

In the diagram 610 and the diagram 620, the controller 12 may control the power supply unit 11 in the first sensing section se1 to supply the reference power w1 to the heater 183. The resistance sensing unit 161 may detect a change in the resistance of the heater 183 when the reference power w1 is supplied to the heater 183. The controller 12 may determine the depletion of the aerosol generating material absorbed by the liquid delivery element 182 based on the change in the resistance of the heater 183 while the reference power w1 is supplied to the heater 183. The controller 12 may determine that the aerosol generating material absorbed by the liquid delivery element 182 is not depleted when the change amount of the resistance of the heater 183 per unit time in the first sensing section se1 is smaller than or equal to the reference change amount rf1. At this time, the unit time may be the duration of the first sensing section se1 and may be the first time t1. In other words, the controller 12 may determine whether the liquid delivery element 182 is depleted by linearly approximating the change amount of the resistance and the reference change amount in the first sensing section se1 and comparing them. The reference change amount rf1 means the change amount of resistance of the heater 183 per unit time, and thus the reference change amount rf1 may be referred to as a reference change rate and a reference slope. For example, the reference change amount may be set to, but is not limited to, 4 [Ω/sec]. Therefore, in an embodiment where the reference change amount rf1 is the reference slope, the controller 12 may determine that the aerosol generating material absorbed by the liquid delivery element 182 is not depleted when the change amount of the resistance of the heater 183 per unit time is smaller than or equal to the reference slope (however, the reference slope is positive). In the diagram 610 and the diagram 620, the controller 12 may determine that the liquid delivery element 182 is not depleted because the change amount of the resistance of the heater 183 per unit time in the first sensing section se1 is smaller than or equal to the reference slope rf1.

When the controller 12 determines that the liquid delivery element 182 is not depleted in the first sensing section se1, the controller 12 may supply the reference power w1 to the heater 183 in the second sensing section se2 that is continuous to the first sensing section se1.

The controller 12 does not determine the depletion of the liquid delivery element 182 based only on the change amount of the resistance of the heater 183 in a single section, in the sensing sections se2 to se4 after the first sensing section se1.

The controller 12 may control the power supply unit 11 to supply the reference power w1 to the heater 183 in the second sensing section se2 that is continuous to the first sensing section se1. The resistance sensing unit 161 may detect a change in the resistance of the heater 183 when the reference power w1 is supplied to the heater 183. The controller 12 may obtain a first change amount, which is the change amount of the resistance of the heater 183 per unit time, while the reference power w1 is supplied to the heater 183. At this time, the unit time means the difference between the second time t2 and the first time t1 as the length of the second sensing section se2 and may be identical to the first time t1. The first change amount refers to an amount of change of the resistance of the heater 183 per unit time, and thus the first change amount may be referred to as a first rate of change and a first slope of change. In other words, the controller 12 may linearly approximate the first change amount in the second sensing section se2.

The controller 12 may control the power supply unit 11 to supply the reference power w1 to the heater 183 in the third sensing section se3 that is continuous to the second sensing section se2. The resistance sensing unit 161 may detect a change in the resistance of the heater 183 when the reference power w1 is supplied to the heater 183. The controller 12 may obtain a second change amount, which is the change amount of the resistance of the heater 183 per unit time, while the reference power w1 is supplied to the heater 183. At this time, the unit time means the difference between the third time t3 and the second time t2 as the length of the third sensing section se3 and may be identical to the first time t1. The second change amount refers to an amount of change of the resistance of the heater 183 per unit time, and thus the second change amount may be referred to as a second rate of change and a second slope of change. In other words, the controller 12 may linearly approximate the second change amount in the third sensing section se3.

The controller 12 may determine the depletion of the aerosol generating material absorbed by the liquid delivery element 182 based on the first change amount, which is the change amount of the resistance of the heater 183 per unit time in the second sensing section se2, and the second change amount, which is the change amount of the resistance of the heater 183 per unit time in the third sensing section se3. The controller 12 may determine that the aerosol generating material absorbed by the liquid delivery element 182 is depleted in the third sensing section se3 when the second change amount is greater than the first change amount. In an embodiment where the first change amount and the second change amount are slopes, the controller 12 may determine that the aerosol generating material absorbed by the liquid delivery element 182 in the third sensing section se3 is depleted when the second slope of change is greater than the first slope of change. In other words, the controller 12 may determine whether the aerosol generating material absorbed by the liquid delivery element 182 is depleted by comparing the slopes of the first change amount and the second change amount (here, the first change amount and the second change amount that are linearly approximated are positive numbers). In the diagram 610 and the diagram 620, the controller 12 may determine that the liquid delivery element 182 is depleted in the third sensing section se3, because the change amount of the resistance of the heater 183 per unit time in the third sensing section se3 is greater than the change amount of the resistance of the heater 183 per unit time in the second sensing section se2.

Meanwhile, although FIG. 7 shows that the second sensing section se2 is a section continuous to the first sensing section se1, according to embodiments, the second sensing section se2 may be a section not continuous to the first sensing section se1. In other words, the controller 12 may determine the depletion of the liquid delivery element 182 in the third sensing section se3 and the fourth sensing section se4. Also, the controller 12 may determine the depletion of the liquid delivery element 182 in the first sensing section se1 and the second sensing section se2.

In the diagram 610 and the diagram 620, when the controller 12 determines that the aerosol generating material absorbed by the liquid delivery element 182 in a current sensing section is depleted, the controller 12 may control the power supply unit 11 in a compensation section subsequent to a current sensing section to supply a compensation power w2 lower than the reference power w1 to the heater 183. In FIG. 7, the current sensing section corresponds to the third sensing section se3 in which depletion of the liquid delivery element 182 is sensed, and the compensation section corresponds to fourth sensing section se4 in which the compensation power w2 lower than the reference power w1 is supplied to the heater 183.

In the diagram 610, the controller 12 may determine that the depletion of the aerosol generating material absorbed by the liquid delivery element 182 is resolved when the resistance of the heater 183 decreases in response to the compensation power w2 in the fourth sensing section se4. The controller 12 may determine whether the depletion of the liquid delivery element 182 is resolved by monitoring the resistance of the heater 183 corresponding to the compensation power w2 in real time or by monitoring the change amount of the resistance of the heater 183 per unit time. In an embodiment where the controller 12 monitors the change amount of the resistance of the heater 183 per unit time, the controller 12 may determine that the depletion of the liquid delivery element 182 has been resolved when the slope of the change amount of the resistance of the heater 183 per unit time is negative in response to the compensation power w2. In other words, the controller 12 may linearly approximate the change amount of the resistance of the heater 183 in the compensation section and determine whether the depletion of the liquid delivery element 182 is resolved based on the sign of the slope of a linearly approximated change amount of the resistance of the heater 183.

To distinguish between depletion of the storage unit 181 and depletion of the liquid delivery element 182, the compensation power w2 is selected within the range from 0.3 times to 0.6 times the reference power w1, as shown in FIG. 6.

When the controller 12 determines that the depletion of the liquid delivery element 182 has been resolved in the fourth sensing section se4, which is a compensation section, the controller 12 may control the power supply unit 11 in a sensing section continuous to the compensation section to supply the reference power w1 to the heater 183 again. In other words, when the controller 12 determines that the depletion of the liquid delivery element 182 has been resolved in the fourth sensing section se4, which is a compensation section, the controller 12 may control the power supply unit 11 in a fifth sensing section (not shown) continuous to the fourth sensing section se4 to supply the reference power w1 to the heater 183.

Contrary to the diagram 610, in the diagram 620, even though the controller 12 supplies the compensation power w2 smaller than the reference power w1 to the heater 183 in the fourth sensing section se4, the resistance of the heater 183 may increase in response to the compensation power w2. When the resistance of the heater 13) increases in response to the compensation power w2 in the fourth sensing section se4, the controller 12 may determine that the storage unit 181 is depleted and the depletion of the liquid delivery element 182 may not be resolved by controlling power. The controller 12 may determine whether storage depletion of the storage unit 181 is resolved by monitoring the resistance of the heater 183 corresponding to the compensation power w2 in real time or by monitoring the change amount of the resistance of the heater 183 per unit time. In an embodiment where the controller 12 monitors the change amount of the resistance of the heater 183 per unit time, the controller 12 may determine that the storage unit 181 is depleted when the slope of the change amount of the resistance of the heater 183 per unit time is positive in response to the compensation power w2. In other words, the controller 12 may linearly approximate the change amount of the resistance of the heater 183 in a compensating section and determine whether the storage unit 181 is depleted based on the sign of the slope of a linearly approximated change amount of the resistance of the heater 183.

When the controller 12 determines that the storage unit 181 is depleted in the fourth sensing section se4, which is a compensation section, the controller 12 may control the power supply unit 11 in a sensing section continuous to the compensation section to block power supplied to the heater 183. In other words, when the controller 12 determines that the storage unit 181 is depleted in the fourth sensing section se4, which is a compensation section, the controller 12 may control the power supply unit 11 in the fifth sensing section (not shown) continuous to the fourth sensing section se4 to block power supplied to the heater 183.

Meanwhile, when the controller 12 determines that the storage unit 181 is depleted, the controller 12 may control the output unit 16 to visually, audibly, and tactilely notify the depletion status of the storage unit 181 to a user.

Meanwhile, when the controller determines that the liquid delivery element 182 and/or the storage unit 181 are depleted in the last section of one puff (1 puff), the power supplied to the heater 183 is not adjusted since there is no subsequent sensing section, and the method of FIGS. 6 and 7 is repeated in a subsequent puff.

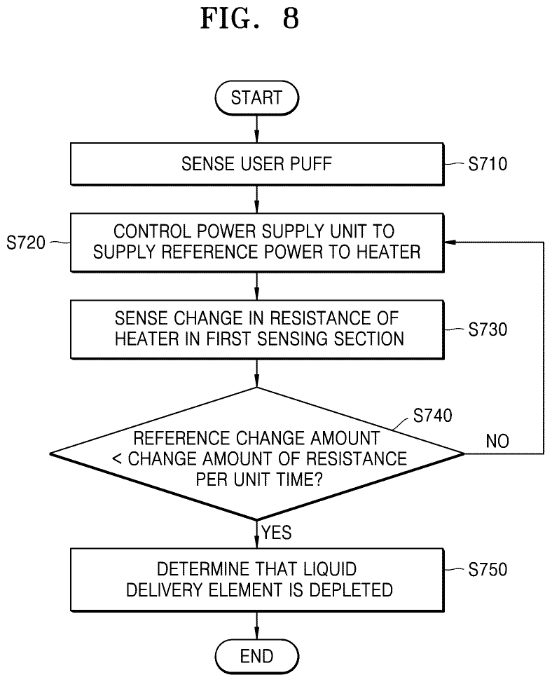

FIG. 8 is a flowchart illustrating a method of determining depletion of a liquid delivery element in a first sensing section according to an embodiment.

Referring to FIG. 8, in operation S710, the puff sensing unit 162 may detect a puff of a user.

The puff sensing unit 162 includes at least one of a pressure sensor, a flow sensor, an airflow sensor, and a microphone, and may transmit a result of detecting a puff to the controller 12. The controller 12 may determine the depletion of an aerosol generating material absorbed by the liquid delivery element 182 in real time in each puff section.

In operation S720, the controller 12 may control the power supply unit 11 to supply reference power to the heater 183.

The power supply unit 11 includes the battery 111 and the power conversion unit 112, and the controller 12 may supply reference power to the heater 183 according to the start of a puff.

In operation S730, the resistance sensing unit 161 may detect a change in the resistance of the heater 183 in a first sensing section.

The resistance sensing unit 161 may output the resistance value of the heater 183 in real time and transmit the resistance value to the controller 12. The controller 12 may monitor the change in the resistance of the heater 183 while supplying reference power to the heater 183. The controller 12 divides one puff section including a puff start time and a puff end time into a plurality of sensing sections, and may monitor the change of the resistance of the heater 183 in the first sensing section from the puff start time to a first time. The change of the resistance of the heater 183 may be expressed as the change of the resistance of the heater 183 per unit time, and the controller 12 may monitor the change of the resistance of the heater 183 per unit time in real time in the first sensing section. According to an embodiment, the change amount of the resistance of the heater 183 per unit time may be expressed as a linearly approximated slope.

In operation S740, the controller 12 may compare a reference change amount with the change amount of the resistance of the heater 183 per unit time.

The controller 12 may compare the reference change amount with the change amount of the resistance of the heater 183 per unit time in the first sensing section. In an embodiment where the reference change amount and the change amount of the resistance of the heater 183 per unit time are slopes, the controller 12 may compare a reference slope with the slope of the resistance of the heater 183.

When the change amount of the resistance of the heater 183 per unit time in the first sensing section se1 is less than or equal to the reference change amount, the controller 12 determines that the liquid delivery element 182 is not depleted and continues to supply the reference power to the heater 183. In an embodiment where the reference change amount and the change amount of the resistance of the heater 183 per unit time are slopes, when the slope of the resistance of the heater 183 is less than or equal to the reference slope in the first sensing section se1, the controller 12 determines that the liquid delivery element 182 is not depleted and thus continues to supply the reference power to the heater 183.

In operation S750, the controller 12 may determine that the liquid delivery element 182 is depleted when the change amount of the resistance of the heater 183 per unit time in the first sensing section se1 is greater than the reference change amount.

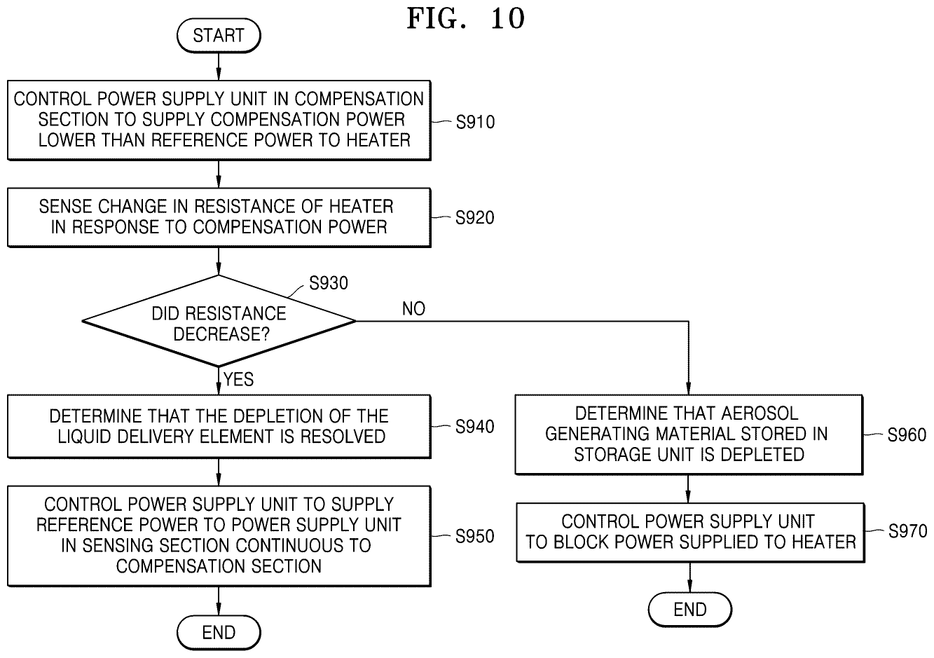

In an embodiment where the reference change amount and the change amount of the resistance of the heater 183 per unit time are slopes, when the slope of the resistance of the heater 183 is greater than the reference slope in the first sensing section, the controller 12 may determine that the liquid delivery element 182 is depleted. The power control method in a subsequent sensing section when the liquid delivery element 182 is depleted is described later with reference to FIG. 10.

Meanwhile, according to the disclosure, it is determined whether the liquid delivery element 182 is depleted only based on the change of the resistance of the heater 183 in the first sensing section, which is a single sensing section, at the beginning of a puff. This is because, in the first sensing section, which is the beginning of a puff, there is no previous sensing section, and, in the early stage of heating, the need to prevent carbonization of the liquid delivery element 182 due to a rapid temperature increase is greater than that in subsequent sensing sections.

Also, when determining the depletion of the liquid delivery element 182, the aerosol generating device 1 according to the disclosure does not compare absolute values with each other, but compares slopes, which are change amounts per unit time, with each other. This is because heaters 183 may have different resistance values due to manufacturing tolerances even in the initial state when the heaters 183 are not heated, and, in this case, when the depletion of the liquid delivery element 182 is determined through the same absolute reference values, accurate depletion determinations may not be made.

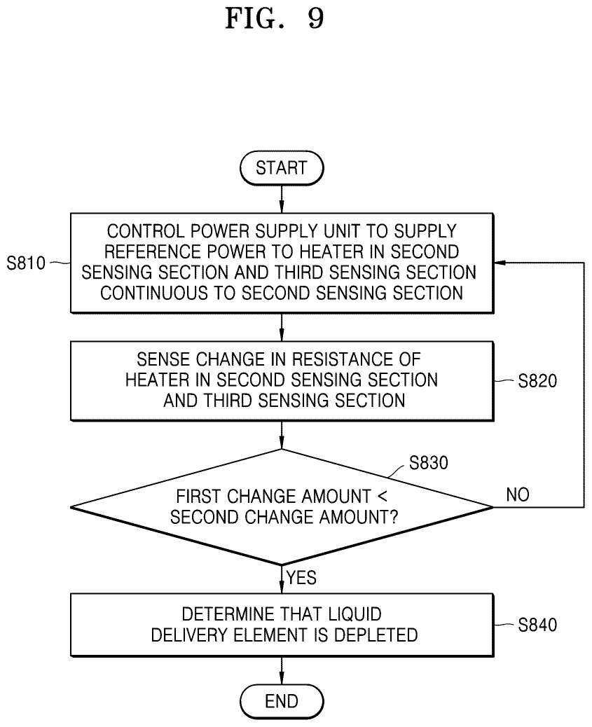

FIG. 9 is a flowchart illustrating a method of determining depletion of a liquid delivery element in a second sensing section and a third sensing section, according to an embodiment.

Referring to FIG. 9, in operation S810, the controller 12 may control the power supply unit 11 to supply the reference power to the heater 183 in the second sensing section and the third sensing section continuous to the second sensing section.

A sensing section includes a first sensing section and a plurality of subsequent sensing sections following the first sensing section, and the controller 12 may determine depletion of the liquid delivery element 182 in the subsequent sensing sections. The second sensing section and the third sensing section do not necessarily have to be sections that are continuous to the first sensing section of FIG. 8, and, according to embodiments, the second sensing section may refer to a section a certain time has elapsed from the first sensing section.

In operation S820, the controller 12 may sense a change in the resistance of the heater 183 in each of the second sensing section and the third sensing section.

The resistance sensing unit 161 may output the resistance value of the heater 183 in real time and transmit the resistance value to the controller 12. The controller 12 may monitor the change in the resistance of the heater 183 while supplying reference power to the heater 183. The controller 12 may divide one puff section including a puff start time and a puff end time into a plurality of sensing sections. According to an embodiment, the controller 12 may divide one puff section into a first sensing section from the puff start time to a first time and a plurality of sensing sections following the first sensing section, and the controller 12 may monitor changes of the resistance of the heater 183 in the plurality of subsequent sensing sections. The change of the resistance of the heater 183 may be expressed as the change of the resistance of the heater 183 per unit time, and the controller 12 may monitor the change of the resistance of the heater 183 per unit time in real time in the plurality of subsequent sensing sections. According to an embodiment, the change amount of the resistance of the heater 183 per unit time may be expressed as a linearly approximated slope.

The controller 1) may obtain a first change amount, which is the change amount of resistance of the heater 183 per unit time in the second sensing section, and a second change amount, which is the change amount of resistance of the heater 183 per unit time in the third sensing section, from the resistance value of the heater 183 output by the resistance sensing unit 161.

In operation S830, the controller 12 may compare the first change amount in the second sensing section with the second change amount in the third sensing section.

The controller 12 may store the first change amount in the second sensing section in the memory 14 and compare the first change amount with the second change amount in the third sensing section. In an embodiment where the first change amount and the second change amount are slopes, the controller 12 may compare the first slope of change with the second slope of change.

When the second change amount is less than or equal to the first change amount, the controller 12 determines that the liquid delivery element 182 is not depleted and continues to supply the reference power to the heater 183. In an embodiment where the first change amount and the second change amount are slopes, when the second change amount is less than or equal to the first change amount in the third sensing section, the controller 12 determines that the liquid delivery element 182 is not depleted and continues to supply the reference power to the heater 183.

In operation S840, the controller 12 may determine that the liquid delivery element 182 is depleted when the second change amount is greater than the first change amount.

In an embodiment where the first change amount and the second change amount are slopes, when the second change amount is greater than the first change amount in the third sensing section, the controller 12 may determine that the liquid delivery element 182 is depleted. The power control method in a subsequent sensing section when the liquid delivery element 182 is depleted is described later with reference to FIG. 10.

Meanwhile, according to the disclosure, it is determined whether the liquid delivery element 182 is depleted based on change amounts of resistance in a plurality of sensing sections after the first sensing section, which is the initial stage of a puff. This is because, unlike the initial puff, the change of resistance is not rapid due to the threshold resistance of the heater 183 in subsequent sensing sections, and thus it is difficult to set a reference slope that may distinguish such low slopes in the subsequent sensing sections. Also, since the resistance of the heater 183 varies in each section, it is difficult to efficiently manage the limited capacity of the memory 14 when separate standards are set for respective sections.

FIG. 10 is a flowchart illustrating a power control method according to depletion of a liquid delivery element and a method of determining depletion of a storage unit according to an embodiment.

Referring to FIG. 10, in operation S910, when the liquid delivery element 182 is depleted, the controller 12 may control the power supply unit 11 in a compensation section to supply compensation power lower than reference power to the heater 183.

The compensation section may refer to an section after a sensing section in which the depletion of the liquid delivery element 182 is determined. To distinguish between depletion of the storage unit 181 and depletion of the liquid delivery element 182, the compensation power w2 may be selected within the range from 0.3 times to 0.6 times the reference power w1.

In operation S920, the resistance sensing unit 161 may sense a change in the resistance of the heater 183 corresponding to the compensation power.

The resistance sensing unit 161 may output the resistance value of the heater 183 in real time and transmit the resistance value to the controller 12. The controller 12 may monitor the change in the resistance of the heater 183 while supplying compensation power to the heater 183. A change in resistance may be expressed as a change amount of resistance per unit time, and the controller 12 may monitor the change amount of resistance of the heater 183 per unit time in real time in a compensation section. According to an embodiment, the change amount of the resistance of the heater 183 per unit time may be expressed as a slope.

In operation S930, the controller 12 may determine whether the resistance of the heater 183 is reduced according to the supply of compensation power.

The controller 12 may determine whether the depletion of the liquid delivery element 182 is resolved by monitoring the resistance of the heater 183 corresponding to the compensation power in real time or by monitoring the change amount of the resistance of the heater 183 per unit time.

In operation S940, the controller 12 may determine that the depletion of the liquid delivery element 182 has been resolved when the resistance of the heater 183 decreases in response to the compensation power.

In an embodiment where the controller 12 monitors the change amount of the resistance of the heater 183 per unit time, the controller 12 may determine that the depletion of the liquid delivery element 182 has been resolved when the slope of the change amount of the resistance of the heater 183 per unit time is negative in response to the compensation power.

In operation S950, when the controller 12 determines that the depletion of the liquid delivery element 182 has been resolved, the controller 12 may control the power supply unit 11 in the sensing section continuous to the compensation section, to supply the reference power to the heater 183 again.

When the controller 12 determines that the depletion of the liquid delivery element 182 has been resolved in the compensation section, the controller 12 repeatedly perform operation S910 while the reference power is being supplied to the heater 183.

In operation S960, when the resistance of the heater 183 increases even though the controller 12 supplies compensation power smaller than the reference power to the heater 183 in the compensation section, it may be determined that an aerosol generating material stored in the storage unit 181 is depleted.

In an embodiment where the controller 12 monitors the change amount of the resistance of the heater 183 per unit time, the controller 12 may determine that the storage unit 181 is depleted when the slope of the change amount of the resistance of the heater 183 per unit time is positive in response to the compensation power.

In operation S970, when the controller 12 determines that the storage unit 181 is depleted, the controller 12 may control the power supply unit 11 to block the power supplied to the heater 183.

When the controller 12 determines that the storage unit 181 is depleted, the controller 12 blocks power supplied to the heater 183 even when a puff of a user is detected and stops heating the heater 183 until a new cartridge 18 is inserted. Also, when the controller 12 determines that the storage unit 181 is depleted, the controller 12 may control the output unit 16 to output the depletion status of the storage unit 181, such that the cartridge may be replaced. A user may insert a new cartridge 18 into the body 10 in response to the indication of an depletion status of the storage unit 181.

Meanwhile, the aerosol generating device 1 according to the disclosure may distinguish between depletion of the liquid delivery element 182 and depletion of the storage unit 181 through changes in the resistance of the heater 183 and notify depletion states to a user. In particular, in the case of depletion of the storage unit 181, depletion of the liquid delivery element 182 may not be resolved until a cartridge is replaced, and thus the disclosure may more reliably prevent carbonization of the liquid delivery element 182 by notifying the depletion of the storage unit 181 to a user.

Any or all of the embodiments described above are neither exclusive nor distinct from each other. Any or all of the embodiments described above may be combined or used in combination with each other in their respective configurations or functions.

For example, a component A described in a particular embodiment and/or diagram may be combined with a component B described in another embodiment and/or diagram. In other words, even when the coupling between components is not directly described, it means that the coupling is possible, except in cases where coupling is described as impossible.

The detailed descriptions given above should not be construed as limiting in any respect and should be considered illustrative only. The scope of the disclosure should be determined by a reasonable interpretation of the appended claims, and all changes coming within the equivalent scope of the disclosure are intended to be included within the scope of the disclosure.

Since an aerosol generating device of the disclosure determines the depletion of a liquid delivery element based on the resistance of a heater, a separate component for determining the depletion of the liquid delivery element is not needed, and thus the manufacturing cost is reduced and product miniaturization is possible.

Also, since the aerosol generating device determines the depletion of the liquid delivery element based on the rate of change in the resistance of the heater rather than the absolute value of the resistance of the heater, there is no need to compensate for manufacturing deviation of the heater for determination of the depletion, and the depletion of the liquid delivery element may be determined more accurately.

Also, the aerosol generating device may control power according to the depletion of the liquid delivery element, thereby increasing user satisfaction by reducing burnt taste and unpleasant odor.

Meanwhile, when a storage unit where an aerosol generating material is stored is depleted, the liquid delivery element is unable to absorb the aerosol generating material, and, in this case, it is impossible to resolve the depletion of the liquid delivery element by controlling power only. Therefore, the aerosol generating device of the disclosure may further increase user satisfaction by determining even the depletion of the storage unit and notifying the depletion to a user.

Also, the aerosol generating device may notify the user when the storage unit is depleted and request replacement of the storage unit, and the user may easily replace the storage unit to prevent carbonization of the liquid delivery element.

The effects of embodiments are not limited by the contents exemplified above, and more various effects are included in the present specification.

What is claimed is:

1. An aerosol generating device comprising:
a power supply unit;
a cartridge comprising a storage unit storing an aerosol generating material, a liquid delivery element absorbing the aerosol generating material, and a heater configured to receive power from the power supply unit and heat the aerosol generating material absorbed in the liquid delivery element;
a resistance sensing unit configured to detect a resistance value of the heater that varies as the heater is heated; and
a controller configured to control the power supply unit to supply reference power to the heater and determine depletion of the aerosol generating material absorbed by the liquid delivery element, based on a change in resistance of the heater while the reference power is supplied to the heater.

2. The aerosol generating device of claim 1, further comprising a puff sensing unit configured to sense a puff of a user,
wherein the controller is further configured to determine the depletion of the aerosol generating material absorbed by the liquid delivery element in each puff section.

3. The aerosol generating device of claim 1, wherein the controller is further configured to divide one puff section comprising a puff start time to a puff end time into a plurality of sensing sections and determine the depletion of the aerosol generating material absorbed by the liquid delivery element, based on a change in the resistance of the heater in a first sensing section from the puff start time to a first time.

4. The aerosol generating device of claim 3, wherein the controller is further configured to determine that the aerosol generating material absorbed by the liquid delivery element is depleted when a change in the resistance of the heater per unit time in the first sensing section is greater than a reference change amount.

5. The aerosol generating device of claim 1, wherein the controller is further configured to divide one puff section comprising a puff start time to a puff end time into a first sensing section from the puff start time to a first time and a plurality of subsequent sensing sections after the first sensing section and determine the depletion of the aerosol generating material absorbed by the liquid delivery element, based on a change in the resistance of the heater in the plurality of subsequent sensing sections.

6. The aerosol generating device of claim 5, wherein the plurality of subsequent sensing sections comprise a second sensing section and a third sensing section continuous to the second sensing section, and
the controller is further configured to determine the depletion of the aerosol generating material absorbed by the liquid delivery element, based on a first change amount, which is a change amount of the resistance of the heater per unit time in the second sensing section, and a second change amount, which is a change amount of the resistance of the heater per unit time in the third sensing section.

7. The aerosol generating device of claim 6, wherein the controller is further configured to determine that the aerosol generating material absorbed by the liquid delivery element is depleted in the third sensing section when the second change amount is greater than the first change amount.

8. The aerosol generating device of claim 1, wherein the controller is further configured to control the power supply unit in a compensation section continuous to a current sensing section to provide a compensation power smaller than the reference power to the heater when it is determined that the aerosol generating material absorbed by the liquid delivery element is depleted in the current sensing section.

9. The aerosol generating device of claim 8, wherein the controller is further configured to determine that the depletion of the aerosol generating material absorbed by the liquid delivery element has been resolved when the resistance of the heater decreases in response to the compensation power in the compensation section and supply the reference power to the heater by controlling the power supply unit in a sensing section continuous to the compensation section.

10. The aerosol generating device of claim 8, wherein the controller is further configured to determine that the aerosol generating material stored in the storage unit is depleted when the resistance of the heater increases in response to the compensation power in the compensation section.

11. The aerosol generating device of claim 10, wherein the controller is further configured to control the power supply unit to block power supplied to the heater in a sensing section continuous to the compensation section when it is determined that the aerosol generating material stored in the storage unit is depleted.

12. The aerosol generating device of claim 10, further comprising an output unit configured to output a status of the aerosol generating device,
wherein the controller is further configured to control the output unit to output a state of depletion of the aerosol generating material stored in the storage unit when it is determined that the aerosol generating material stored in the storage unit is depleted.
